(19) United States
(12) Patent Application Publication
(10) Pub. No.: US 2025/0034988 A1
(43) Pub. Date: Jan. 30, 2025

(54) DOWNHOLE ELECTRONICS ENCAPSULATION AGAINST GAS INVASION

(71) Applicant: Halliburton Energy Services, Inc., Houston, TX (US)

(72) Inventors: Jebreel M M SALEM, Houston, TX (US); Krutibas Panda, Houston, TX (US); Xuesong Ou, Houston, TX (US); Imran Sharif Vehra, Houston, TX (US)

(73) Assignee: Halliburton Energy Services, Inc., Houston, TX (US)

(21) Appl. No.: 18/226,915

(22) Filed: Jul. 27, 2023

(51) Int. Cl. E21B 47/017; C09D 163/10

(52) U.S. Cl. CPC E21B 47/017; C09D 163/10

(57) ABSTRACT

An electronics encapsulation for preventing gas invasion is provided. An example downhole tool can comprise a drilling assembly and a sensor secured to the drilling assembly. The sensor can include a circuit board, wherein at least a portion of a surface of the circuit board is covered with a coating made of an epoxy resin composition comprising one or more benzene rings.

### TECHNICAL FIELD

The present disclosure generally relates to downhole electronics. For example, aspects of the present disclosure relate to the encapsulation of downhole electronics against gas invasion.

### BACKGROUND

Wells are drilled at various depths to access and produce hydrocarbons such as oil and gas from subterranean geological formations. Particularly, hydrocarbons may be produced from a wellbore that traverses one or more subterranean formations. In the process of completing such a wellbore, modern drilling operations may include gathering information relating to the conditions encountered downhole. Such information typically includes characteristics of the formations traversed by the borehole, and data relating to the characteristics of the borehole itself. The collection of information can be performed by several methods, including wireline logging, logging while drilling (LWD), measurement while drilling (MWD), drill pipe conveyed logging, and coil tubing conveyed logging.

In LWD or MWD, a drilling assembly includes sensing instruments that measure various parameters of the formation during drilling. While LWD and MWD techniques allow formation measurements to be taken during drilling, drilling operations may create an environment that is hostile to electronic instrumentation or sensor operations, for example, a gas invasion into the electronic components or sensors.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not, therefore, to be considered to be limiting of its scope, the principles herein are described and explained with additional specificity and detail through the use of the accompanying drawings in which:

FIG. 1A is a schematic side-view of an example logging while drilling (LWD) wellbore operating environment, according to some examples of the present disclosure.

FIG. 1B is a schematic side-view of the example downhole environment of FIG. 1A, according to some examples of the present disclosure.

FIG. 2 illustrates an example of an electronic component with coating, in accordance with aspects of the present disclosure.

FIG. 3 illustrates an example graph of the performance of an electronic component with coating, according to some aspects of the disclosed technology.

FIGS. 4A and 4B illustrate example downhole connectors with coating, according to some aspects of the disclosed technology.

FIG. 5 is a flowchart illustrating an example process for disposing a circuit board that is coated with an epoxy resin composition within a sensor, according to some aspects of the disclosed technology.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein.

In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

As previously described, various well operations, such as stimulation operations and drilling operations, include activities to measure formation properties. For example, wells are drilled at various depths to access and produce hydrocarbons such as oil and gas from subterranean formations.

Many tools such as electrical testers and measurement tools are used in a well for long hours to measure formation properties. These tools include electronic components that are prone to gas invasion at a high temperature in the downhole environment. A gas leak into a downhole tool during the drilling may cause the gas to trap inside the tool. Such gas invasion, particularly an invasion of helium and hydrogen gases that have small atoms, can impact the functionality of some sensors such as Micro-Electromechanical Systems (MEMs) devices and cause malfunction and/or failure of the tool. Further, it has been challenging to prevent the permeation of gases, particularly helium and hydrogen gases due to the small size of their molecules. At an elevated temperature when encapsulation materials soften upon heating, it is easier for helium and hydrogen to get through softened encapsulation materials.

Aspects of the present disclosure relate to encapsulating electronic components against gas invasion. In some examples, the present disclosure can encapsulate downhole electronic components against the invasion of gases (e.g., helium and hydrogen) in the downhole environment.

For example, electronic components (e.g., chips, circuit boards, MEMS components, etc.) that are used in downhole tools can be coated with an epoxy resin composition that comprises one or more benzene rings.

As disclosed herein, the epoxy resin composition can be coated onto the surface of electronic components to prevent or slow down permeation of small molecule gasses such as helium and/or hydrogen as well as larger molecule gasses into the electronic components in the downhole, for example at least between −15° C. and 230° C. In some examples, the epoxy resin composition can be coated onto the surface of electronic components with thickness T and extended distance d. In some aspects, the downhole electronic components can be coated with an epoxy resin composition that comprises at least two benzene rings. Further, the epoxy resin composition can include a crosslinker, a hardener, or a combination thereof.

The present disclosure can provide the encapsulation of electronic component(s) of a downhole tool that can prevent or reduce gas invasion, particularly of helium and hydrogen gases in a downhole environment without adversely affecting the functions of the electronic components.

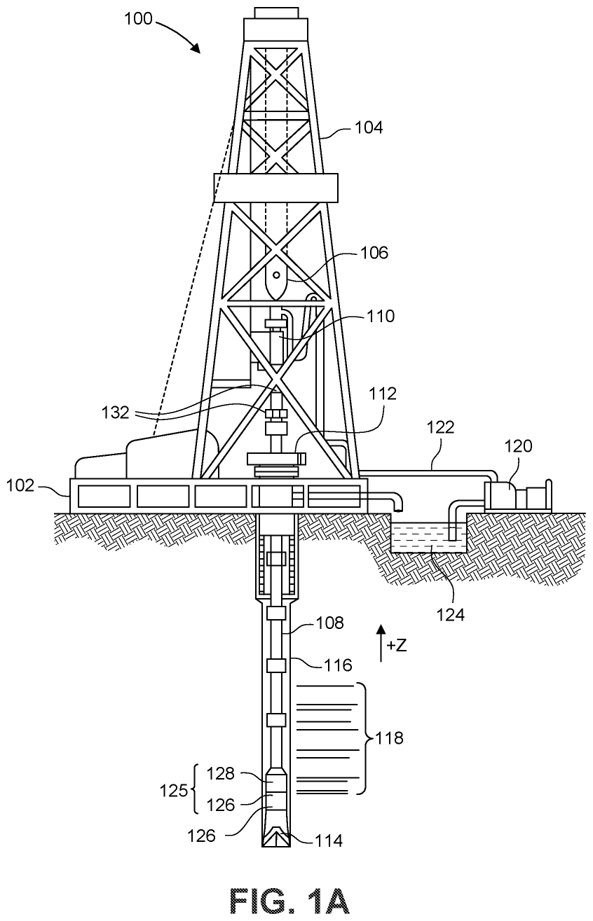

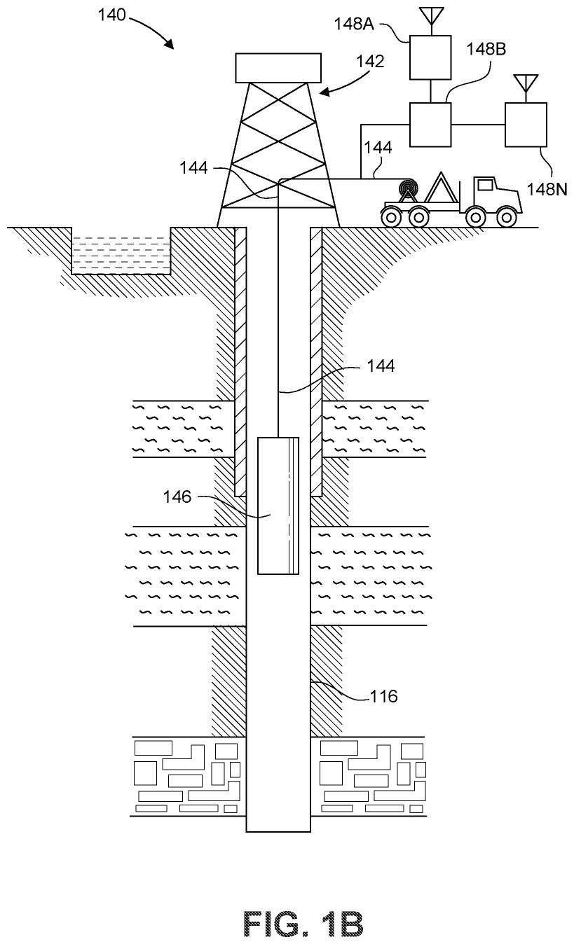

Examples of the systems and techniques described herein are illustrated in FIG. 1A through FIG. 5 and described below.

FIG. 1A is a diagram illustrating an example LWD environment 100, according to some examples of the present disclosure. Specifically, the drilling arrangement shown in FIG. 1A can be used to gather formation data through a tool (e.g., downhole tool 126 as illustrated below) that may include an electronic component, a sensor, a battery, etc. that can be susceptible to gas invasion under an elevated temperature in the downhole environment.

The drilling arrangement of FIG. 1A also exemplifies what is referred to as MWD, which utilizes sensors to acquire data from which the wellbore's path and position in three-dimensional space can be determined. As shown, in this example, a drilling platform 102 supports a derrick 104 that has a traveling block 106 for raising and a lowering drill string 108. A kelly 110 supports the drill string 108 as it is lowered through a rotary cable 112. A drill bit 114 is driven by a downhole motor and/or rotation of the drill string 108. As a drill bit 114 of the drill string 108 rotates, it drills a borehole 116 that passes through one or more formations 118. A pump 120 circulates drilling fluid through a feed pipe 122 to the kelly 110 downhole through the interior of the drill string 108 and orifices in the drill bit 114, back to the surface via the annulus around the drill string 108 and into a retention pit 124. The drilling fluid transports cuttings from the borehole into pit 124 and aids in maintaining borehole integrity.

A downhole tool 126 can take the form of a drill collar (e.g., a thick-walled tubular that provides weight and rigidity to aid the drilling process) or any other known and/or suitable arrangement. Further, the downhole tool 126 can include one or more logging tools such as, for example and without limitation, one or more acoustic (e.g., sonic, ultrasonic, etc.) logging tools and/or one or more other types of logging tools and/or corresponding components. The downhole tool 126 can be integrated into a bottom-hole assembly 125 near the drill bit 114. As the drill bit 114 extends the borehole through formations, the bottom-hole assembly 125 can collect logging data and/or sensor data (e.g., NMR data and/or any other logging and/or sensor data). The downhole tool 126 can include various electronic components that need to be sealed against invasion from the surrounding environment such as gas, moisture, etc. particularly gas, moisture, etc.

For purposes of communication, a downhole telemetry sub 128 can be included in the bottom-hole assembly 125 to transfer measurement data to a surface receiver 132 and receive commands from the surface (e.g., from a device at the surface such as a computer and/or a transmitter). At the surface, the surface receiver 132 can receive the uplink signal from the downhole telemetry sub 128. The surface receiver 132 can include, for example and without limitation, a wireless receiver, a computer (e.g., a laptop computer, a desktop computer, a tablet computer, a server computer, and/or any other type of computer), and/or any other device with data communication capabilities (e.g., wired and/or wireless). In some cases, the surface receiver 132 can communicate the signal from the downhole telemetry sub 128 to a data acquisition system (not shown).

Depending on the implementation, other logging tools may be deployed. For example, logging tools configured to measure electric, nuclear, gamma and/or magnetism levels may be used. Logging tools can also be implemented to measure other properties, events, and/or conditions such as, for example and without limitation, pressure, measure fluid viscosity, measure temperature, perform fluid identification, measure a tool orientation, and/or obtain any other measurements.

At various times during the process of drilling a well, the drill string 108 may be removed from the borehole 116 as shown in FIG. 1B. Once the drill string 108 has been removed, logging operations can be conducted using the downhole tool 126 (e.g., a logging tool, a sensing instrument sonde, etc.) suspended by a conveyance (e.g., conveyance 144 shown in FIG. 1). In some examples, the downhole tool 126 can include an acoustic or sonic logging instrument that collects acoustic logging data within the borehole 116. As mentioned above, other logging instruments may additionally or alternatively be used.

FIG. 1B is a schematic side-view 140 of the example downhole environment 100 of FIG. 1A. A tool having tool body 146 can be employed with “wireline” systems, in order to carry out logging or other operations. For example, instead of using the drill string 108 of FIG. 1A to lower tool body 146, which may contain sensors or other instrumentation for detecting and logging nearby characteristics and conditions of the wellbore and surrounding formation, the tool body 146 can be lowered by a wireline conveyance 144. Thus, as shown in FIG. 1B, the tool body 146 can be lowered into the wellbore 116 by the wireline conveyance 144. The wireline conveyance 144 can be anchored in a drill rig 142 or portable means such as a truck. The wireline conveyance 144 can include one or more wires, slicklines, cables, and/or the like, as well as tubular conveyances such as coiled tubing, joint tubing, or other tubulars.

The illustrated wireline conveyance 144 can provide support for the tool (e.g., tool body 146), enable communication between the tool processors on the surface, and/or provide a power supply. The wireline conveyance 144 can include fiber optic cabling for carrying out communications. The wireline conveyance 144 can be sufficiently strong and flexible to tether the tool body 146 through the wellbore 116, while also permitting communication through the wireline conveyance 144 to one or more local processors 148B and/or one or more remote processors 148A, 148N. Power can be supplied via the wireline conveyance 144 to meet power requirements of the tool. For slickline or coiled tubing configurations, power can be supplied downhole with a battery or via a downhole generator, for example.

Although FIGS. 1A and 1B depict specific borehole configurations, it should be understood that the present disclosure is suited for use in wellbores having other orientations including vertical wellbores, horizontal wellbores, slanted wellbores, multilateral wellbores, and the like. While FIGS. 1A and 1B depict an onshore operation, it should also be understood that the present disclosure is suited for use in offshore operations. Moreover, the present disclosure is not limited to the environments depicted in FIGS. 1A and 1B, and can also be used in other well operations such as, for example and without limitation, production tubing operations, jointed tubing operations, coiled tubing operations, combinations thereof, and/or the like.

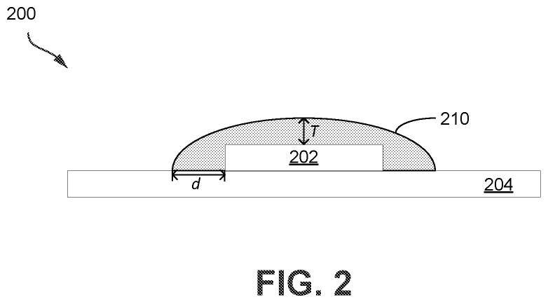

FIG. 2 is a diagram of an example electronic component with coating 200. As shown in FIG. 2, an electronic component 202 (e.g., an electronic chip, an oscillator, etc.) is coupled to a circuit board 204. In some examples, circuit board 204 can be a printed circuit board (PCB), which is used to connect electronic components to one another. The circuit board 204 may be used in a downhole tool (e.g., downhole tool 126 as illustrated in FIG. 1A) as part of a sensor that may be secured to a drilling assembly (e.g., bottom-hole assembly 125), which is configured to collect logging data and/or sensor data.

As illustrated, an exterior surface of electronic component 202 is covered with a coating 210. The coating 210 is applied to seal electronic component 202 against gas invasion, particularly an invasion of helium and hydrogen gases in a downhole environment at least between −15° C. and 230° C.

In some examples, coating 210 can be made of an epoxy resin composition that comprises one or more benzene rings. For example, the epoxy resin composition for coating 210 can comprise at least two benzene rings, which may increase the rigidity of the epoxy resin composition.

In some aspects, the epoxy resin composition can include bis-[4-(2,3-epoxipropoxi)phenyl]propane, which may be represented by the following Formula 1.

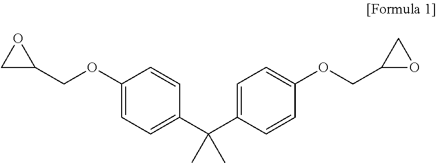 [SMILES: CC(C)(c1ccc(OCC2CO2)cc1)c1ccc(OCC2CO2)cc1]

In Formula 1, the benzene rings in the backbone of bis-[4-(2,3-epoxipropoxi)phenyl]propane can increase the rigidity of the epoxy polymer chain segment. In some cases, each ether bond can be directly linked to a benzene ring. For example, as shown in Formula 1, the ether groups in the epoxy polymer can be linked directly to the benzene rings. The ether bonds, while rendering some flexibility, can help limit the flexibility of these bonds and maintain rigidity under a high temperature as the ether bonds are confined by benzene rings. As follows, the epoxy resin composition for coating 210 can tolerate temperature and prevent or reduce gas permeation at a high temperature, for example in a downhole environment.

In some aspects, the epoxy resin composition for the coating 210 can include a crosslinker (or crosslinking reagent). The butane crosslinker helps to link epoxy polymer chains into a 3-D network and reduce the amount of left-over monomer, thereby providing enhanced barrier properties.

In some examples, the epoxy resin composition for the coating 210 can include a hardener. The hardener may include at least one amide or anhydride. An aromatic group in the amide or anhydride hardeners can help increase a glass transition temperature of the epoxy resin composition. As follows, the amount and flexibility of flexible bonds in the polymer chains of the epoxy resin composition can be minimized to maintain rigidity under an elevated temperature in the downhole environment.

For example, the epoxy resin composition for the coating 210 can comprise bis-[4-(2,3-epoxipropoxi)phenyl]propane and hexahydro-4-methylphthalic anhydride, which may be represented by the following Formula 2.

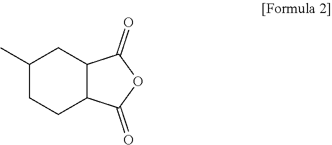

In some cases, additional crosslinker, hardener, or any other additives may be added without departing from the present disclosure. In some aspects, a multilayer encapsulation can be applied using a combination of other conformal coatings, ceramic coating along with the epoxy resin composition of the present disclosure as described herein.

In some examples, the coating 210 can be used to cover at least a portion of the exterior surface of electronic component 202 or encapsulate the entire exterior surface of electronic component 202. The coating 210 can be applied to the surface of electronic component 202 with thickness T. In some aspects, the thickness T of the coating 210 may be in a range between 0.5 mm to 5 mm. The thickness T may be determined based on one or more factors such as a targeted temperature application, the size of a component (e.g., electronic component 202), how a component (e.g., electronic component 202) is mounted on a board (e.g., circuit board 204), a vibration level in the targeted application. While a large coating 210 (e.g., a large thickness I) for sealing, such large coating 210 may increase the mass and impact electronic component 202 at vibrations.

In some approaches, the coating 210 can be used to cover the entire top surface of circuit board 204. For example, the epoxy resin composition for the coating 210 can be applied to the exterior surface of electronic component 202 and the exterior top surface of the circuit board 204 to reduce gas permeation. As an illustrative example, 1.5 mm thickness (T) and 3 mm extended area (d) can be used for coating 210 to ensure the required gas resistance at 150° C. and keep the mass small not to cause a vibration risk.

In some cases, the coating 210 can be applied to the surface of electronic component 202 with extended distance d (e.g., a distance from the boundary of the electronic component 202). The extended distance d of the coating 210 may be in a range between 0.5 mm to 5 mm Thickness T and extended distance d may vary depending on the size, dimension, or characteristics of the electronic component 202 or the circuit board 204.

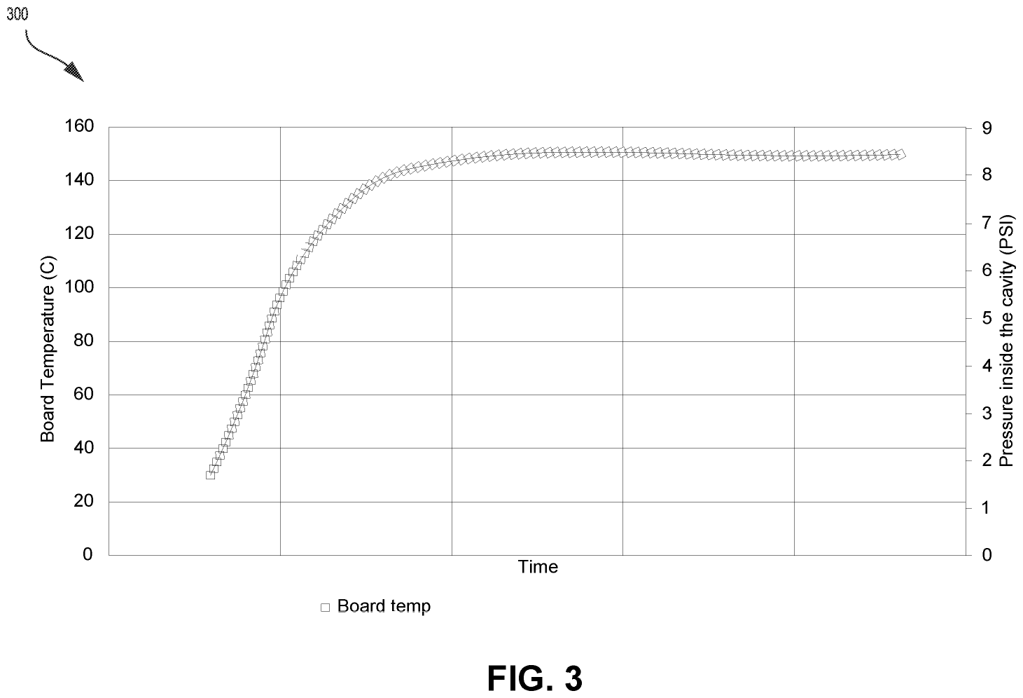

FIG. 3 illustrates an example graph 300 of the performance of an electronic component with coating. The example graph 300 illustrates the performance of a board with electronic component(s) (e.g., circuit board 204 with electronic component 202 as illustrated in FIG. 2) that is coated with an epoxy resin composition (e.g., coating 210) when helium gas (concentration of 80% and 3.0 PSI) is injected. As shown in graph 300, the circuit board that has an electronic component coated with an epoxy resin composition continues to report a temperature steadily around at 150° C. even after an injection of helium gas.

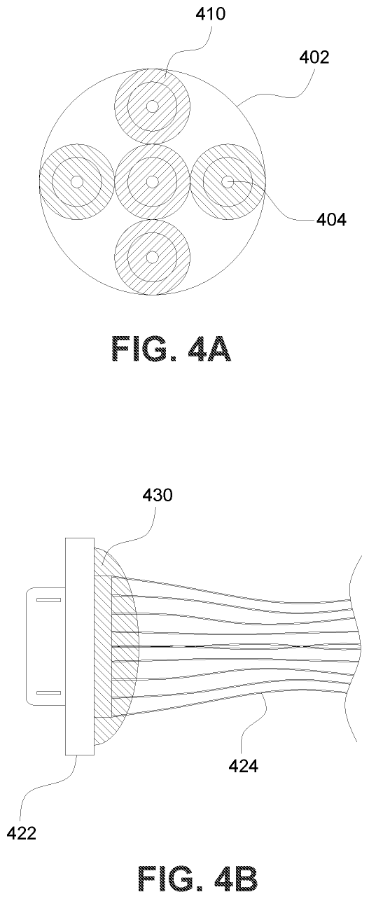

FIGS. 4A and 4B illustrate example downhole connectors with coating. In FIG. 4A, connector 402 of a downhole tool has one or more feedthroughs 404. The surface of feedthrough(s) 404 can be applied with a coating 410, which comprises an epoxy resin composition as illustrated with respect to FIG. 2. In FIG. 4B, a pigtail connector 422 with wires 424 can be coated with a coating 430, which comprises an epoxy resin composition as illustrated with respect to FIG. 2. The epoxy resin composition of coating 410, 430 can prevent and/or reduce gas invasion inside a toll at a high temperature, for example in a downhole environment by sealing the surface that may cause potential leak path for gas permeation (e.g., gas invasion of helium and hydrogen gases) in downhole tools such as junction box or connector-gun drill interface.

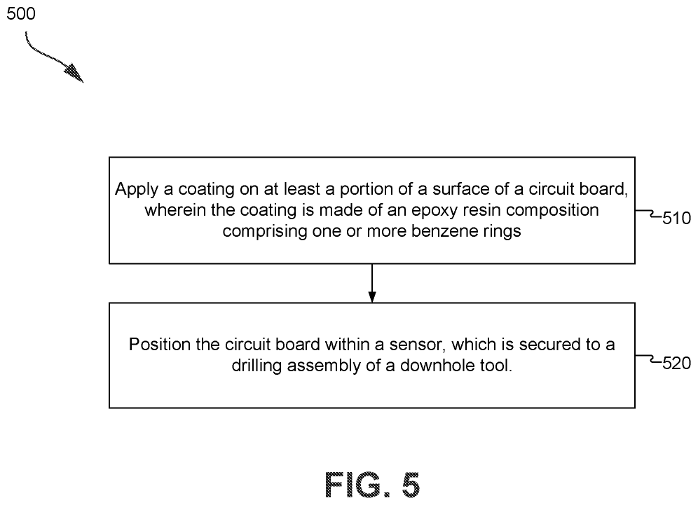

FIG. 5 is a flowchart illustrating an example process 500 of disposing a circuit board that is coated with an epoxy resin composition within a sensor. Although example process 500 depicts a particular sequence of operations, the sequence may be altered without departing from the scope of the present disclosure. For example, some of the operations depicted may be performed in parallel or in a different sequence that does not materially affect the function of process 500. In other examples, different components of an example device or system that implements process 500 may perform functions at substantially the same time or in a specific sequence.

At step 510, process 500 includes applying a coating on at least a portion of a surface of a circuit board (e.g., circuit board 204 as illustrated in FIG. 2 such as a PCB). The coating (e.g., coating 210 as illustrated in FIG. 2) may be made of an epoxy resin composition comprising one or more benzene rings. For example, the epoxy resin composition for the coating can include at least two benzene rings, an ether group, a crosslinker, and/or a hardener (e.g., amide or anhydride group).

In some examples, one or more electronics are secured onto the circuit board. The epoxy resin composition for the coating can be applied to at least a portion of the exterior surface of the electronics (e.g., electronic component 202). For example, a PCB can include electronics (e.g., analog-to-digital converter, memory, and control circuitry), which can be coated with the coating comprising the epoxy resin composition.

In some aspects, the epoxy resin composition for the coating can be applied with thickness T (e.g., in a range between 0.5 mm and 5 mm) and extended distance d (e.g., in a range between 0.5 mm and 5 mm). In some examples, a dam can be used to control the thickness (T) and extended distance (d) around the component (e.g., electronic component 202) After applying coating (e.g., coating 210) on the component (e.g., electronic component 202), the epoxy needs to be cured. The curing process can be done at room temperature or above room temperature (e.g., 160° C.).

At step 520, process 500 includes positioning the circuit board within a sensor, which is secured to a drilling assembly of a downhole tool. For example, the circuit board 204 can be positioned within a sensor, which is secured to a drilling assembly (e.g., bottom-hole assembly 125) of a downhole tool (e.g., downhole tool 126).

As previously described, the sequence of process 500 can be altered without departing from the scope of the present disclosure. In some examples, the coating can be applied after an electronic component is mounted onto a circuit board. In some aspects, the coating can be applied to an electronic component prior to a submission on a circuit board.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

Illustrative examples of the disclosure include:

Aspect 1. A downhole tool comprising: a drilling assembly; and a sensor secured to the drilling assembly, the sensor comprising: a circuit board, wherein at least a portion of a surface of the circuit board is covered with a coating made of an epoxy resin composition comprising one or more benzene rings.

Aspect 2. The downhole tool of Aspect 1, wherein the epoxy resin composition is configured to prevent permeation of helium or hydrogen into the circuit board at least between −15° C. and 230° C.

Aspect 3. The downhole tool of Aspect 1 or 2, wherein the circuit board comprises one or more electronic components mounted on the surface of the circuit board, and an outer surface of the one or more electronic components is covered with the coating made of the epoxy resin composition.

Aspect 4. The downhole tool of any of Aspects 1 to 3, wherein the epoxy resin composition comprises at least two benzene rings.

Aspect 5. The downhole tool of any of Aspects 1 to 4, wherein the epoxy resin composition comprises at least two ether groups.

Aspect 6. The downhole tool of Aspect 5, wherein each of the two ether groups is directly linked to a benzene ring.

Aspect 7. The downhole tool of any of Aspects 1 to 6, wherein a thickness of the coating is in a range between 0.5 mm and 5 mm.

Aspect 8. The downhole tool of any of Aspects 1 to 7, wherein an extended distance of the coating is in a range between 0.5 mm and 5 mm.

Aspect 9. The downhole tool of any of Aspects 1 to 8, wherein the epoxy resin composition comprises a hardener component comprising at least one amide or anhydride.

Aspect 10. The downhole tool of any of Aspects 1 to 9, wherein the epoxy resin composition comprises bis-[4-(2,3-epoxipropoxi)phenyl]propane.

Aspect 11. A method comprising: applying a coating on at least a portion of a surface of a circuit board, wherein the coating is made of an epoxy resin composition comprising one or more benzene rings; and positioning the circuit board within a sensor, which is secured to a drilling assembly of a downhole tool.

Aspect 12. The method of Aspect 11, wherein the epoxy resin composition is configured to prevent permeation of helium or hydrogen into the circuit board at least between −15° C. and 230° C.

Aspect 13. The method of Aspect 11 or 12, wherein the epoxy resin composition comprises at least two benzene rings.

Aspect 14. The method of any of Aspects 11 to 13, wherein the epoxy resin composition comprises at least two ether groups.

Aspect 15. The method of Aspect 14, wherein each of the two ether groups is directly linked to a benzene ring.

Aspect 16. The method of any of Aspects 11 to 15, wherein a thickness of the coating is in a range between 0.5 mm and 5 mm.

Aspect 17. The method of any of Aspects 11 to 16, wherein an extended distance of the coating is in a range between 0.5 mm and 5 mm.

Aspect 18. The method of any of Aspects 11 to 17, wherein the epoxy resin composition comprises a hardener component comprising at least one amide or anhydride.

Aspect 19. The method of any of Aspects 11 to 18, wherein the epoxy resin composition comprises bis-[4-(2,3-epoxipropoxi)phenyl]propane.

Aspect 20. A sensor of a downhole tool, the sensor comprising: a printed circuit board comprising: one or more electronic components mounted on a surface of the printed circuit board, wherein at least a portion of the surface of the printed circuit board is covered with a coating made of an epoxy resin composition comprising one or more benzene rings.

What is claimed is:

1. A downhole tool comprising:
a drilling assembly; and
a sensor secured to the drilling assembly, the sensor comprising:
a circuit board, wherein at least a portion of a surface of the circuit board is covered with a coating made of an epoxy resin composition comprising one or more benzene rings.

2. The downhole tool of claim 1, wherein the epoxy resin composition is configured to prevent permeation of helium or hydrogen into the circuit board at least between −15° C. and 230° C.

3. The downhole tool of claim 1, wherein the circuit board comprises one or more electronic components mounted on the surface of the circuit board, and an outer surface of the one or more electronic components is covered with the coating made of the epoxy resin composition.

4. The downhole tool of claim 1, wherein the epoxy resin composition comprises at least two benzene rings.

5. The downhole tool of claim 1, wherein the epoxy resin composition comprises at least two ether groups.

6. The downhole tool of claim 5, wherein each of the two ether groups is directly linked to a benzene ring.

7. The downhole tool of claim 1, wherein a thickness of the coating is in a range between 0.5 mm and 5 mm.

8. The downhole tool of claim 1, wherein an extended distance of the coating is in a range between 0.5 mm and 5 mm.

9. The downhole tool of claim 1, wherein the epoxy resin composition comprises a hardener component comprising at least one amide or anhydride.

10. The downhole tool of claim 1, wherein the epoxy resin composition comprises bis-[4-(2,3-epoxipropoxi)phenyl]propane.

11. A method comprising:
applying a coating on at least a portion of a surface of a circuit board, wherein the coating is made of an epoxy resin composition comprising one or more benzene rings; and
positioning the circuit board within a sensor, which is secured to a drilling assembly of a downhole tool.

12. The method of claim 11, wherein the epoxy resin composition is configured to prevent permeation of helium or hydrogen into the circuit board at least between −15° C. and 230° C.

13. The method of claim 11, wherein the epoxy resin composition comprises at least two benzene rings.

14. The method of claim 11, wherein the epoxy resin composition comprises at least two ether groups.

15. The method of claim 14, wherein each of the two ether groups is directly linked to a benzene ring.

16. The method of claim 11, wherein a thickness of the coating is in a range between 0.5 mm and 5 mm.

17. The method of claim 11, wherein an extended distance of the coating is in a range between 0.5 mm and 5 mm.

18. The method of claim 11, wherein the epoxy resin composition comprises a hardener component comprising at least one amide or anhydride.

19. The method of claim 11, wherein the epoxy resin composition comprises bis-[4-(2,3-epoxipropoxi)phenyl]propane.

20. A sensor of a downhole tool, the sensor comprising:
a printed circuit board comprising:
one or more electronic components mounted on a surface of the printed circuit board, wherein at least a portion of the surface of the printed circuit board is covered with a coating made of an epoxy resin composition comprising one or more benzene rings.
